(19) United States
(12) Patent Application Publication
(10) Pub. No.: US 2008/0070208 A1
(43) Pub. Date: Mar. 20, 2008

(54) Communication kit

(76) Inventor: Janine A. Wilburn, San Francisco, CA (US)

Correspondence Address: BACON & THOMAS, PLLC, 625 SLATERS LANE, FOURTH FLOOR, ALEXANDRIA, VA, 22314, US

(21) Appl. No.: 11/515,739

(22) Filed: Sep. 6, 2006

(51) Int. Cl. G09B 19/00

(52) U.S. Cl. 434/236

(57) ABSTRACT

A communication kit, for encouraging written communication between members of a family or social group and a remote member of the family or social group, includes a stationery items having visual indicia thereon, the visual indicia including thought-prompts to prompt a user to express a thought or idea in writing. The stationery items comprise thematic sets of stationery items wherein stationery items within each set have thematic visual indicia thereon expressing or relating to a theme that is common to said set. At least one archival medium for recording activities, events, thoughts, and emotions of members of the family or social group, is included in the kit, comprising a plurality of pages having visual indicia prompt a user to record activities, events, thoughts, and emotions which may be recalled later in a written communication. A container has compartments to store the stationery items, archival media, and other articles.

### FIELD OF THE INVENTION

The present invention relates to stationery, and more particularly to a communication kit for encouraging written communication between members of a family or social group and a remote member of the family or social group that provides stationery and other articles to facilitate a family or social group in communicating with the remote member of the family or social group.

### BACKGROUND

Communication between members of a group of people, such as a family or social group, is important to help maintain positive interpersonal relationships between the members of the group. These positive interpersonal relationships contribute greatly to feelings of happiness and well-being of the individual members of the group.

When an individual member of such a group is away from the group for a significant period of time, it may become difficult to maintain communications, and the member away from the group may begin to feel isolated, or removed, from the group. Also, the member away from the group may become anxious about the well-being of other members of the group, and the group may similarly become anxious about the well-being of the member away. Relationships with friends and loved ones may become strained. As these interpersonal relationships become strained, or simply muted due to the distance, members of the group and in particular the member away from the group are likely to be negatively impacted.

Such a situation may arise in a variety of circumstances. One example is a child away from her family for a period of time, such as during a stay at a summer camp. Another situation, which may create perhaps the greatest stresses on both the group and the member away from the group, is a soldier on active duty, who is stationed away from family and friends for a long period of time and perhaps in an unpleasant or even a hostile environment.

For a child away to summer camp, lack of family communications may result in homesickness, and diminished joy and reward from the summer camp experience. For a soldier stationed far from home, and in many cases for a prolonged duration, lack of communications with family, loved ones, or friends at home may result in not only feelings of homesickness, but in deteriorated morale, a deteriorated commitment to the mission, and may perhaps impact negatively on the soldiers decision to reenlist in service.

Fostering or encouraging communications between a family or social group and a remote member of the family or social group can have positive effects ranging from improving a child's summer camp experience to improving morale among soldiers. Of particular interest to military and similar organizations is that a soldier, whose morale is improved by improved family communications, may be more likely to reenlist than a soldier whose morale has deteriorated as a result of lack of such communications. In other situations, families may be separated due to a variety of situations, such as divorce, illness, and other reasons.

However, numerous barriers often exist to communication, and particularly to written communications. People are often reluctant, or find it difficult, to write notes, letters, or post cards, for numerous reasons. People may have a sense of “writers block,” or a feeling that they don't know what to write. It may be difficult to remember events to relate, as memories of significant and “noteworthy” events may fade over time. A writer may not want to relive some events in the process of committing a memory to written communication, or the excitement and energy associated with an event may be lost over time, such that if a letter is not sent quickly following the event the event may become difficult to recall, or difficult to communicate.

People may also feel that a long letter is needed to “catch up” for a long time apart with no communication. Unfortunately, one result of a long time apart may be that rather than to write a quick note, people may delay or put off the task of writing a long letter which may be perceived to be a difficult or time consuming task. As more time goes by, more time becomes lost since a previous communication and a perception of the would-be writer grows that the length of a letter must increase according to the time since the previous communication. A vicious cycle grows as the would-be writer puts off the task of writing the letter again and again, waiting to have enough time or to recall enough to write. Finally, it simply takes time to write a letter, or to shop for and then write a card, and time for such tasks may frequently be found to be scarce.

Another result of a long time apart may be that, as the time apart increases, the time between communications grows while the length of communications becomes shorter, conveying a diminishing sense of connectedness to the member who is away or apart from the group.

While advancements in electronic telecommunications media and facilities, such as the Internet and associated technological innovations, provide for a quick exchange of communications, digital or cyber communications, usually in an electronic form such as email, tend to be intangible and short lived. Written, physical communications such as letters or post cards are tangible and long lived, and may be easily shared or stored to be read again and again.

Because of their tangible, physical nature, such written communications may provide a greater impact than digital or cyber communications. A physical letter may include photographs, or other mementos also in a physical, tangible form. A letter, in a physical form, may be retained by a soldier and carried, and re-read, in places or situations where an electronic communication device may be impractical or impossible.

An effective means to assist and encourage members of a group of people, such as family or social group, with preparation and sending of written communications to a remote member of the group is thus needed.

### SUMMARY

The present invention is a communication kit for encouraging and facilitating written communication between members of a group of people, such as family or social group, and a remote member of the group. The communication kit provides stationery items and other articles that make easier the task of preparing and sending written communications individuals or by members of a family or social group to another individual or a remote family or social group member.

Within the communication kit, stationery items preferably are provided that include visual indicia comprising thought-prompts that prompt a user to express a thought or idea in writing. The stationery items include stationery items oriented to quick, short, and easy communications, and stationery items oriented to longer and more substantive communications that help to foster and reinforce deep, emotional connections.

Thought prompts assist a writer in preparing written communications by helping the writer to recall activities, events, thoughts, emotions, and the like to be written onto a stationery item, thereby relieving the difficulty that often surrounds a written correspondence task of determining what to write. Thought prompts may be in the form of single words or partial sentences, or in the form of multiple choice selections, or in graphical or pictorial forms. Thought prompts may be tailored to families or groups in specific situations, such as a family or social group where a remote member is a soldier on active duty and stationed away from the family or group.

In a preferred embodiment, plural sets of stationery items are provided, typically organized within a convenient container, including sets of stationery items that are oriented to free-form, or long and in-depth communications, and sets of stationery items that are oriented to quick, short and easy communications.

Additionally, the plural sets of stationery items in an embodiment of the invention include sets of stationery items expressing or relating to a theme common to a set. The themes may be expressed by the subject matter of the thought prompts, or by separate thematic visual indicia, or both. Such themes may be selected to appeal to certain subsets of the family or social group. For example, a visual or subject matter theme may appeal or relate especially to children, to adults, to male or female members of the family or social group, or the like. The communication kit is therefore oriented to multiple family members or members of a social group.

The communication kit includes in another embodiment of the invention at least one archival medium, such as a journal, photo album, diary, scrapbook, and the like, for recording activities, events, thoughts, emotions, and the like, of members of the family or social group. The archival medium may include visual indicia comprising thought prompts and thematic expressions, similar to the thought prompts and thematic expressions of the stationery items. The thought prompts of the archival medium prompt a user to fill in pages with written expressions, photos, news articles or other publications, and other media.

Components of the communication kit may be stored in a container, providing various compartments for, or dividers separating, the stationery items, archival media, and other articles included in the communication kit.

These and other features, aspects, and advantages of the present invention will become better understood with regard to the following description, appended claims, and accompanying drawings.

### BRIEF DESCRIPTION OF THE DRAWINGS

FIG. 1 is a diagram showing the relationship between a communication kit according to the present invention, a family or social group, and a remote member of the family or social group.

FIG. 2 is a perspective view of a communication kit according to one embodiment of the present invention.

FIG. 3a is a front perspective view of a tri-fold self mailer included in one embodiment of a communication kit, having visual indicia including thought prompts and thematic expressions.

FIG. 3b is a rear perspective view of the tri-fold self mailer shown In FIG. 2, having thematic visual indicia.

FIG. 4 is a front perspective view of a post card included in one embodiment of a communication kit, having thought prompts in the form of partial sentences and multiple-choice selections.

FIG. 5 is a perspective view of a journal of one embodiment of a communication kit, having visual indicia in the form of thought prompts on plural inner pages of the journal.

FIG. 6 is a perspective view of a photo album of one embodiment of a communication kit, having visual indicia in the form of thought prompts on an inner page of the photo album.

FIG. 7 is a perspective view of emotive stickers that may be included in certain embodiments of a communication kit.

FIG. 8 is a front view of a T-shirt having visual indicia in the form of thought prompts, along with a marker for marking a written communication on the T-shirt.

### DETAILED DESCRIPTION OF VARIOUS PREFERRED EMBODIMENTS

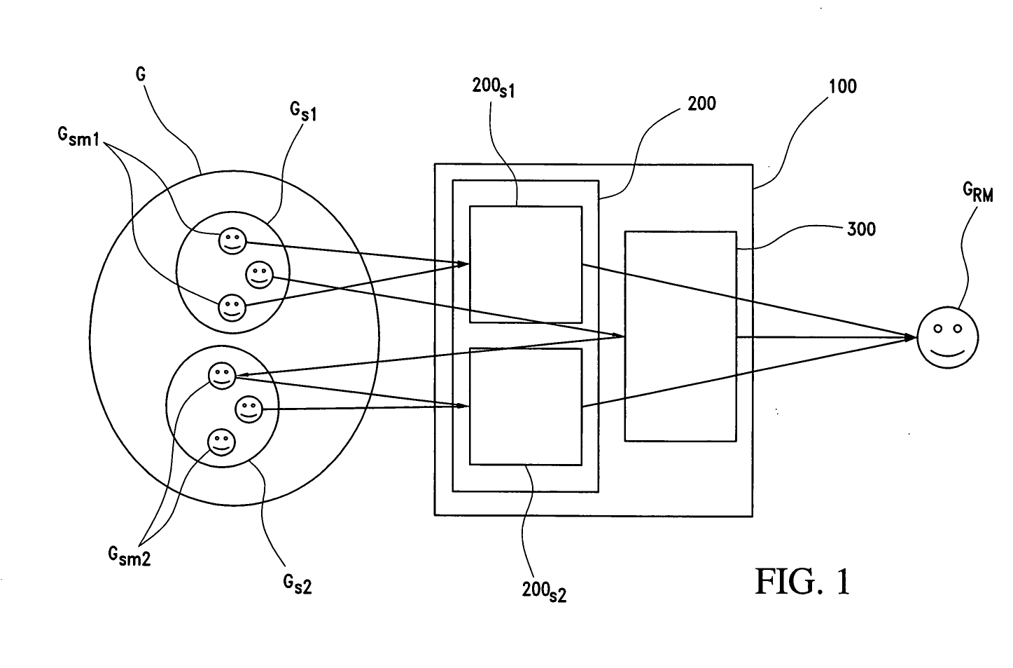

Referring to FIGS. 1, the present invention in accordance with a preferred embodiment includes a communication kit 100 for encouraging and facilitating written communication between at least one member of a family or social group G and a remote member Gᵣₘ of the family or social group who is located away, or remotely, from the family or social group G. It can be recognized, of course, that a family or social group may comprise as few as two members including the remote member.

The family or social group G may comprise a plurality of members of the group, which may often be considered to include plural subgroups Gₛ₁, Gₛ₂. Subgroups Gₛ₁, Gₛ₂ may be identified, for example, wherein members Gₛₘ₁ of a first subgroup Gₛ₁ are children, while members Gₛₘ₂ of a second subgroup Gₛ₂ are adults. These subgroup divisions are somewhat arbitrary, and may be identified based on numerous characteristics shared by members of the group G.

The group G itself is generally characterized by some common relationship between all of the group members, such as all members of a family or a social group. With regard to the communication kit 100 of the present invention, each of the members of the group G also has some relationship with or to the remote member Gᵣₘ.

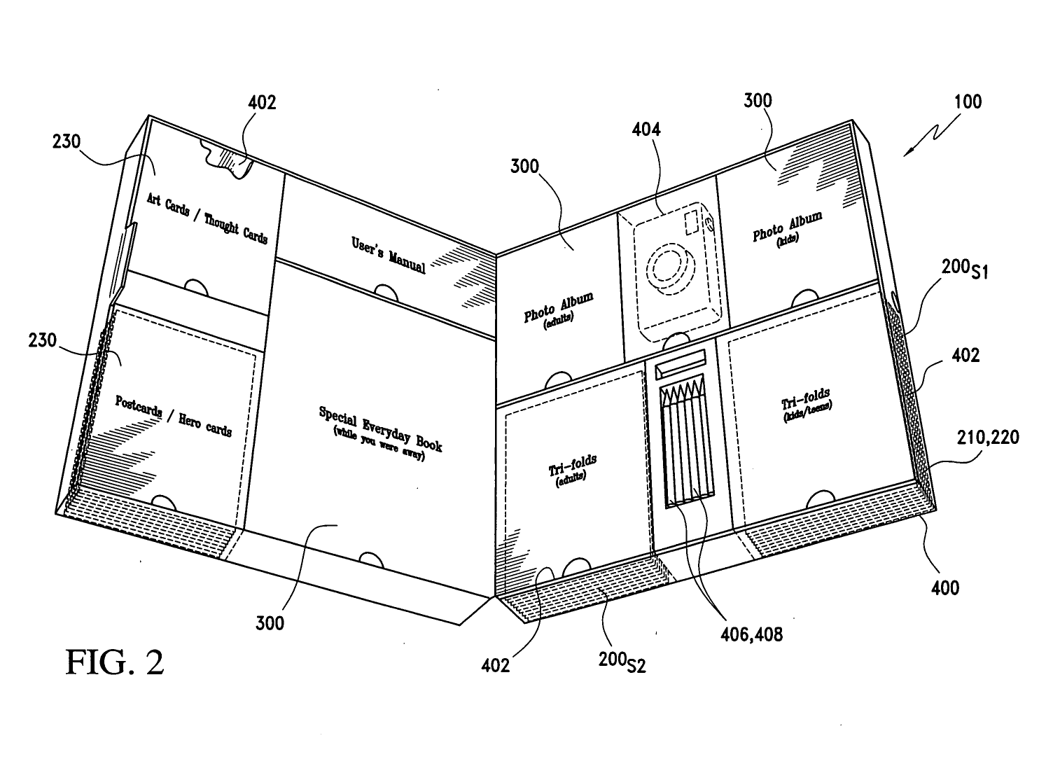

Turning now to FIG. 2, an embodiment of a communication kit 100 is shown comprising a plurality of stationery items 200 and at least one archival medium 300, each stored within various compartments 402 of a container 400. In other embodiments, a container may be in the form of a folio, box, bag, folder, or other types of a container.

The stationery items 200 provide a means for a user, such as a member of a family or social group, to create and send written communications (letters, notes, post cards, and the like), while archival media 300 facilitate recording of activities, events, thoughts, emotions, and the like, of members of the family or social group. The communication kit 100 facilitates written communication from members of a family or social group by providing thought prompts on the stationery items to assist a user in recalling thoughts and ideas for preparing a written communication.

Also, the archival media 300 allows for recordation of activities, events, thoughts, emotions, and the like, for future recall to assist in preparing a written communication. Thus, the communication kit 100 includes media and tools needed for members of the family or social group to prepare and send personal written communications to the remote member of the family or social group without the burden of recalling themes, events, or memories to write about.

The stationery items 200 may be provided in a variety of types. In addition to plain stationery for lengthy, free-form letters, the stationery items 200 may include self mailers 210 or post cards 230 that are oriented towards quick, easy communication. The self mailers 210 and post cards 230 may include visual indicia thereon, which include thought prompts, thematic expressions, or both.

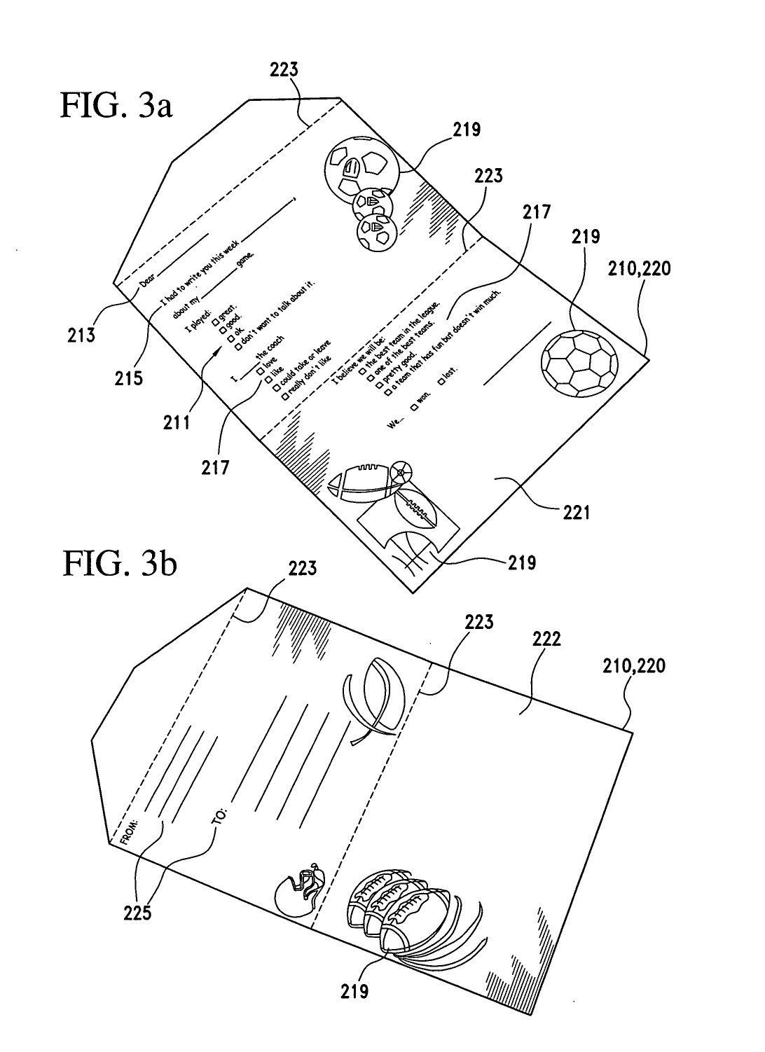

Referring to FIG. 3a, one example of a self mailer 210 is shown in the form of a tri-fold self mailer 210. Thought prompts 211 are shown in the form of single words 213, partial sentences 215, and multiple choice selections 217. The thought prompts 211 express an idea or subject to prompt a writer to express his or her thoughts relating to the idea or subject, including activities, events, thoughts, and emotions of the writer. Generally speaking, a thought-prompt 211 is a textual expression that suggests a topic for a complete sentence, although a thought-prompt may include pictorial or graphical elements. A typical thought prompt 211 comprises at least one word, or a partial sentence, that suggests a topic for a complete sentence.

For example, a partial sentence “Today in school I ______” prompts a child or student to complete a sentence about one or more activities, events, thoughts, or emotions recalled from a day's school experiences.

A thought prompt 211 may also be in the form of a multiple choice selection 217, whereby a complete thought may be expressed by simply selecting at least one of a list of options.

The self mailer 210 illustrated in FIG. 3a also includes thematic visual indicia 219. Thematic visual indicia 219 express themes of interest or appeal or relevance to users of the communication kit 100, and thereby increase the appeal of the communication kit 100 and of the task of using elements of the communication kit 100 to prepare and send a written communication. Generally, thematic visual indicia 219 comprise graphical, image, or pictorial elements, although thematic visual indicia 219 may include textual expressions as well.

The stationery items 200 may include plural sets of stationery items, wherein stationery items 200 within each set express or relate to a theme that is common to the set. The theme may be reflected in the subject matter of thought prompts 211 on the stationery items, or may be reflected by thematic visual indicia 219, or both.

A set of stationery items may be defined by a broad theme that relates to a subset Gₛ₁, Gₛ₂ of a group G of users or the communication kit 100, such as a subset of adult members, or a subset of child members, of the group G. Alternatively, a set of stationery items may be defined by narrower theme such as a particular subject matter.

One example of a thematic set of stationery items might be a set of stationery items that include thematic visual indicia 219 that are images of sports equipment and play included with thought prompts 211 that relate to a child's sports activities.

The plural sets of stationery items may include at least a first set 200ₛ₁ of stationery items 200 wherein said thematic visual indicia 219 express themes of interest or appeal or relevance to a first subset Gₛ₁ of members of said family or social group, and a second set 200ₛ₂ of stationery items 200 wherein said thematic visual indicia 219 express themes of interest or appeal or relevance to a second subset Gₛ₂ of members of said family or social group. In one example, the members of the first subset Gₛ₁ of members of the family or social group are adults, and the members of the second subset Gₛ₂ of members of the family or social group are children.

A tri-fold self mailer 220 generally comprises a single sheet of stationery that is foldable along two folding lines 223 to enclose a message, written on a first side 221 of the tri-fold self mailer (TBD), for mailing.

Referring now to FIG. 3b, a self mailer 210 may be characterized by the inclusion of addressing indicia 225 on one side of the self mailer that provide a space for the user to enter postal or addressing information such as the address of the addressee and a return address. In the case of the tri-fold self mailer 210, the addressing indicia 225 is located on a second side 222 of the tri-fold self mailer 220 so that, when the tri-fold self mailer 220 is folded to enclose a message written on a first side 221, the addressing indicia 225 remains visible on the outside of the tri-fold self mailer 220.

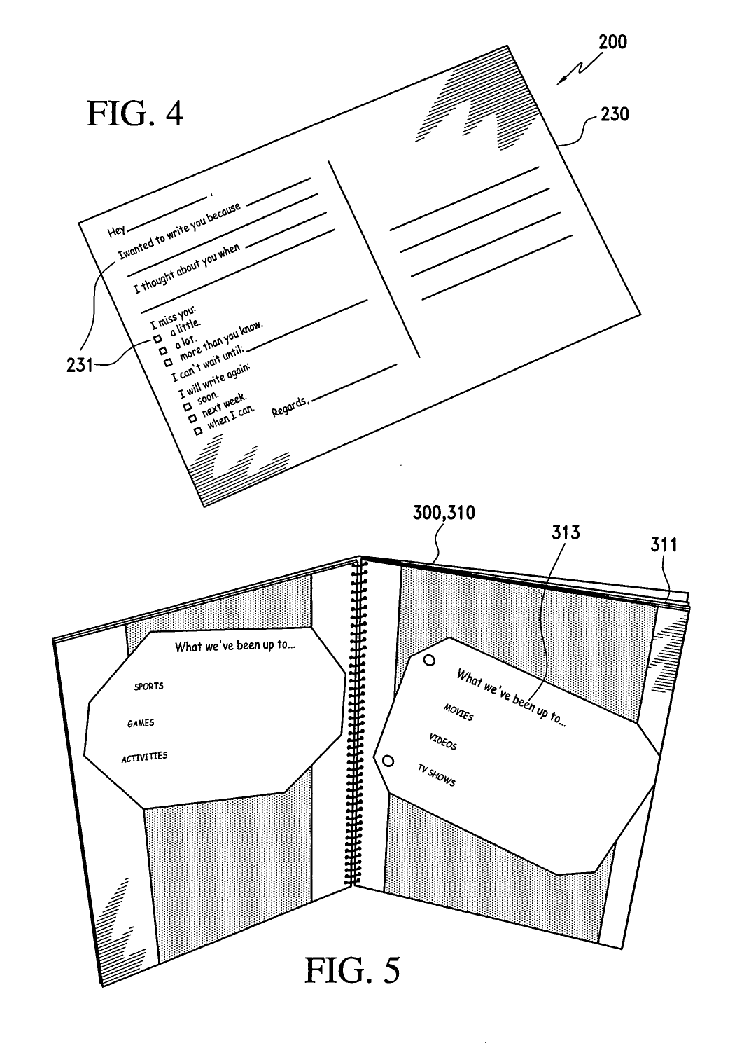

Turning to FIG. 4, the stationery items 200 are shown in the form of post cards 230. The post cards 230 may include thought prompts 231, or may have a blank field for free form entry of text. The communication kit 100 may include plural sets of post cards 230, wherein sets may be defined by thematic indicia or by the subject matter of thought prompts in the post cards.

Archival media 300 in the communication kit 100 allow members of the family or social group to record activities, events, thoughts, emotions, and the like. Thus, a record may be created, covering a long time interval, of the activities, events, thoughts, and emotions of the family or social group members that may be of interest to the remote member. The recording of these activities, events, thoughts, and emotions facilitates their recall for the purpose of a written communication, assisting a writer in both completing communications based on thought prompts 211 of the stationery items, and in completing unprompted writings. Additionally, an archival medium 300 may be sent to the remote member of the family or social group.

Turning to FIG. 5, archival media 300 may be in the form of a journal or scrapbook 310. The journal or scrapbook 310 provides a medium for recording activities, events, thoughts, and emotions, in the form of written journal entries or entry of photos, news articles or clippings, or other mementos recorded or entered into the journal or scrapbook 310. The journal or scrapbook 310 includes plural pages 311 and may include visual indicia in the form of thought prompts 313 that suggest or prompt the entry or recordation of writings, photos, news articles, clippings, and other mementos relating to activities, events, thoughts, and emotions of a member of the family or social group.

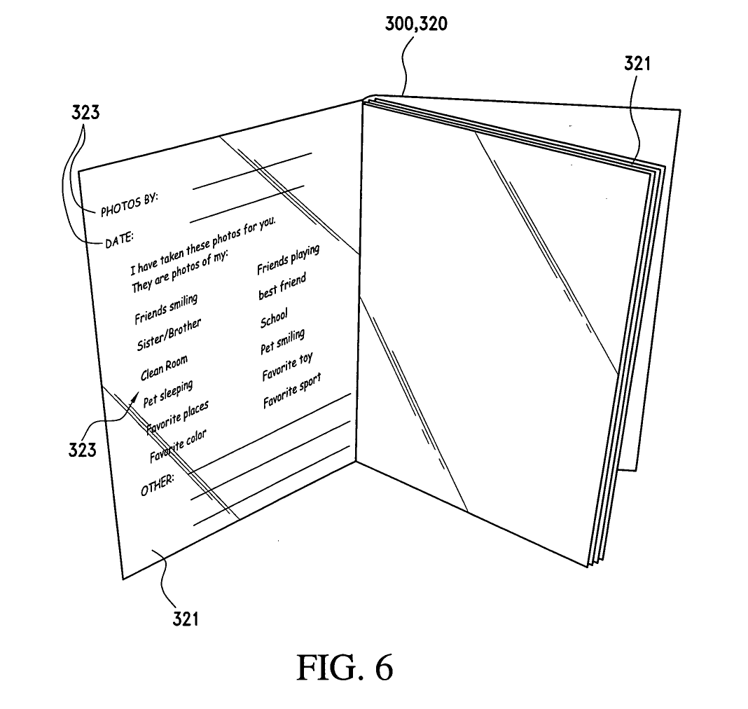

Turning to FIG. 6, an archival medium 300 may be in the form of a photo album 320. A photo album 320 comprises plural pages 321 for insertion or affixation of one or more photographs. At least one page 321 may include visual indicia such as thought prompts 323 to prompt a user for the insertion or affixation of photographs taken to record or to reflect specific activities, events, thoughts, and emotions.

Thus, the archival media 300, whether in the form of a journal or scrapbook, a diary, a photo album, or another form, facilitate and prompt the recordation of activities, events, thoughts, and emotions of members of the family or social group. As records of activities, events, thoughts, and emotions are added to the archival media 300, the archival media provide a resource to recall the recalled recorded activities, events, thoughts, and emotions for inclusion in written communications to the remote member of the family or social group.

In addition to providing a resource to recall the recalled recorded activities, events, thoughts, and emotions for inclusion in written communications, an archival medium 300 may itself be sent to the remote member of the family or social group. For such purpose, archival media 300 may be provided in a self mailing form, or may be provided with suitable mailing envelopes to enclose one or more of the archival media 300 for delivery through a postal service.

The communication kit 100 may further include a camera 404 for taking pictures to be entered into an archival medium 300 or to be included with written communications to the remote member of the family or social group.

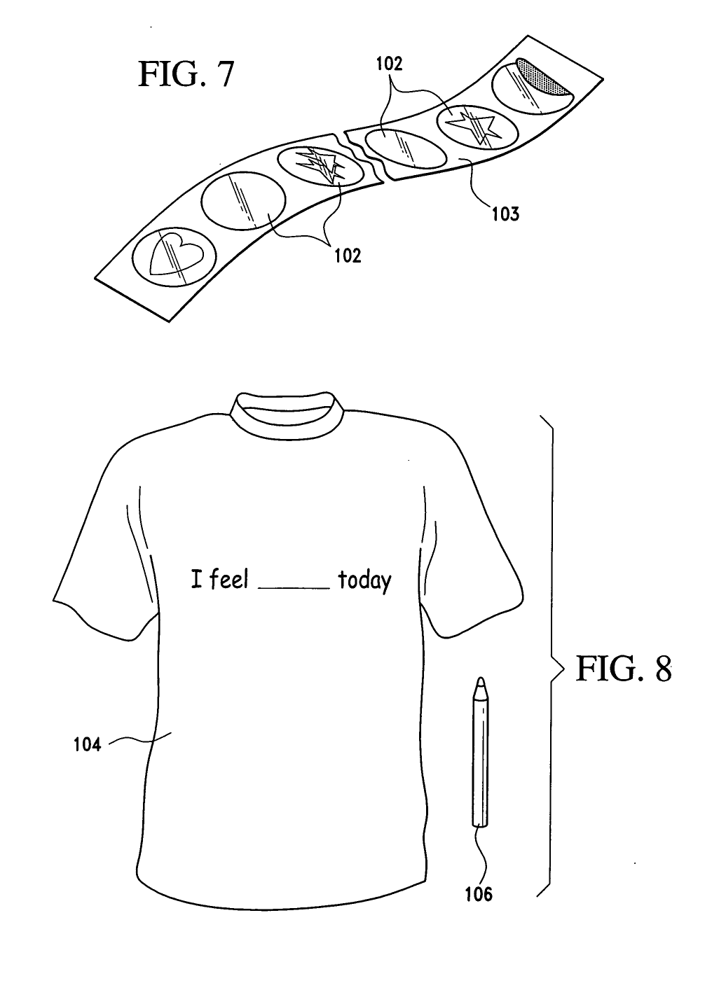

The communication kit 100 may further include one or more writing implements 406 such as a set of pens or pencils. Colored writing implements 408 may be employed to add to the visual impact or appeal of written communications or to entries in the archival media 300. Preferably, the kit will contain various items for expression of thoughts and occurrences in any convenient, readily available manner. Various forms of the kit can be envisioned as well, where the number and variety of the mediums and implements can be varied for marketing purposes. In certain embodiments, the communication kit 100 may also include emotive stickers 102 that may be applied, for example, to any of the stationery items 200. Referring to FIG. 7, a plurality of emotive stickers 102 may be provided removably disposed on a backing 103. Referring to FIG. 8, T-shirts 104, provided along with fabric markers 106 and mailers, may also be included in certain embodiments of the communication kit 100. The T-shirts 104 may be printed with thought prompts that suggest an idea or subject for customization of the T-shirt 104 using the fabric marker 106.

It will be understood that the above-described embodiments of the invention are illustrative in nature, and that modifications thereof may occur to those skilled in the art. Accordingly, this invention is not to be regarded as limited to the embodiments disclosed herein, but is to be limited only as defined in the appended claims.

I claim:

1. A communication kit for encouraging written communication between at least one member of a family or social group and a remote member of the family or social group, comprising:
a plurality of stationery items, each of said stationery items having visual indicia thereon comprising at least one thought-prompt to prompt a user to express a thought or idea in writing on said stationery item;
at least one archival medium for recording activities, events, thoughts, and emotions of members of the family or social group, the archival medium comprising a plurality of pages having visual indicia thereon to prompt a user to enter a record of an activity, event, thought or emotion in said archival medium; and
containing means for containing at least said stationery items and said archival medium in an organized manner.

2. The communication kit according to claim 1, wherein said stationery items comprise at least a first set of stationery items having thematic visual indicia that express themes of interest or appeal or relevance to a first subset of members of said family or social group, and at least a second set of stationery items having thematic visual indicia that express themes of interest or appeal or relevance to a second subset of members of said family or social group.

3. The communication kit according to claim 2, wherein the members of said first subset of members of said family or social group are adult, and the members of said second subset of members of said family or social group are children.

4. The communication kit according to claim 1, wherein said thought-prompt suggests a topic for a complete sentence.

5. The communication kit according to claim 1, wherein said thought-prompt comprises at least one word that suggests a topic for a complete sentence.

6. The communication kit according to claim 1, wherein said thought-prompt comprises one of a partial sentence and a multiple-choice selection.

7. The communication kit according to claim 1, wherein said plurality of stationery items further comprises at least one thematic set of stationery items wherein stationery items within said thematic set have thematic visual indicia thereon expressing or relating to a theme that is common to said thematic set.

8. The communication kit according to claim 1, further comprising at least one writing implement.

9. The communication kit according to claim 1, wherein said containing means comprises a compartmented container.

10. The communication kit according to claim 9, wherein said container comprises at least one compartment for said stationery items, and at least one compartment for said archival medium.

11. A communication kit for encouraging written communication between members of a family or social group and a remote member of the family or social group, comprising:
a plurality of stationery items, each of said stationery items having visual indicia thereon comprising at least one thought-prompt to prompt a user to express a thought or idea in writing on said stationery item;
said plurality of stationery items comprising a plurality of sets of stationery items wherein stationery items within each set have thematic visual indicia thereon expressing or relating to a theme that is common to said set; and
a compartmented container having a plurality of stationery compartments for storing said sets of stationery items.

12. The communication kit according to claim 11, further comprising at least one archival medium for recording activities, events, thoughts, and emotions of members of the family or social group, the archival medium comprising a plurality of pages having visual indicia thereon to prompt a user to enter a record of an activity, event, thought, or emotion in said archival medium.

13. The communication kit according to claim 12, wherein said archival medium comprises at least one of a journal, a diary, a scrapbook, and a photo album.

14. The communication kit according to claim 11, wherein said plurality of sets of stationery items comprises at least one set of self mailers.

15. The communication kit according to claim 14, wherein said at least one set of self mailers comprises at least a first set of self mailers having thematic visual indicia expressing themes of interest or appeal or relevance to a first subset of members of said family or social group, and at least a second set of self mailers having thematic visual indicia expressing themes of interest or appeal or relevance to a second subset of members of said family or social group.

16. The communication kit according to claim 14, wherein said at least one set of self mailers comprises at least a first set of self mailers having thematic visual indicia expressing themes of interest or appeal or relevance to adult members of said family or social group, and at least a second set of self mailers having thematic visual indicia expressing themes of interest or appeal or relevance to child members of said family or social group.

17. The communication kit according to claim 14, wherein said thought-prompt suggests a topic for a complete sentence to be completed by a member of said family or social group.

18. The communication kit according to claim 14, wherein said thought-prompt comprises a partial sentence that suggests a topic for a complete sentence to be completed by a member of said family or social group.

19. A communication kit for encouraging written communication between members of a family or social group and a remote member of the family or social group, comprising:
archival means for making and keeping a record of activities, events, thoughts, and emotions of members of the family or social group;
stationery means for assisting a member of the family or social group in expressing thoughts in writing and for communicating said written thoughts to the remote member of the family or social group; and
containing means for containing at least said stationery items and said at least one archival medium in an organized manner.

20. The communication kit according to claim 19, wherein said archival means comprises at least one of a journal, a diary, a scrapbook, and a photo album.

21. The communication kit according to claim 19, wherein said stationery means comprises a plurality of stationery items, each of said stationery items having visual indicia thereon comprising at least one thought-prompt to prompt a user to express a thought or idea in writing on said stationery item.

22. The communication kit according to claim 19, wherein said containing means comprises a compartmented container having at least one compartment for said archival means and at least one compartment for said stationery means.
